(19) United States
(12) Patent Application Publication
(10) Pub. No.: US 2024/0208140 A1
(43) Pub. Date: Jun. 27, 2024

(54) METHOD FOR PRINTING MICROLAYERS AND MULTILAYERED NANOSTRUCTURES ORDERED BY CHAOTIC FLOWS

(71) Applicant: INSTITUTO TECNOLOGICO Y DE ESTUDIOS SUPERIORES DE MONTERREY, Zapopan (MX)

(72) Inventors: Grissel TRUJILLO DE SANTIAGO, Monterrey (MX); Mario MOISES ALVAREZ, Monterrey (MX); Carlos Fernando CEBALLOS GONZALEZ, Monterrey (MX); Edna Johana BOLIVAR MONSALVE, Monterrey (MX); Maria DIAZ DE LEON DERBY, Monterrey (MX); Carolina CHAVEZ MADERO, Monterrey (MX); Daniele TAMMARO, Napoles (IT); Ernesto DI MAIO, Napoles (IT)

(21) Appl. No.: 18/288,512

(22) PCT Filed: Mar. 11, 2022
(86) PCT No.: PCT/IB2022/052219

§ 371 Date: Oct. 26, 2023

(30) Foreign Application Priority Data
Apr. 29, 2021 (MX) MX/A/2021/004963

(51) Int. Cl. B29C 64/209; B29B 7/00; B29B 7/32; B29B 7/60; B29C 64/106; B29C 64/314; B33Y 10/00; B33Y 30/00

(52) U.S. Cl. CPC B29C 64/209; B29B 7/007; B29B 7/325; B29B 7/60; B29C 64/106; B29C 64/314; B33Y 10/00; B33Y 30/00

(57) ABSTRACT

The present invention refers to a method for printing microlayers and multilayered nanostructures obtained by chaotic flows comprising the following steps: i) feeding a static mixer with at least two inks; ii) promoting the inks to flow through the static mixer to create chaotic flows; iii) promoting the solidification of the inks at the outlet of the static mixer to obtain a laminar structure and; iv) printing the inks by extrusion. The present invention also refers to a chaotic printer for microlayers and multilayered nanostructures obtained by chaotic flows comprising: a) a pump; b) a static mixing module and; c) at least one printhead, which allows the extrusion of inks with internal nanostructures.

### FIELD OF THE INVENTION

The present invention is related to chaotic printing, and more particularly it is related to a method for printing microlayers and multilayered nanostructures obtained by chaotic flows.

### BACKGROUND OF THE INVENTION

Currently there are micro and nanofabrication technologies of thin layers, such as three-dimensional (3D) printing, which refers to the group of additive manufacturing technologies, where a three-dimensional object is manufactured by overlapping successive layers of a material, commonly the material is a polymer. Among the best known technologies for the manufacture of thin layers are stereolithography and nanoprinting. Stereolithography is an additive manufacturing process that uses UV curing resin in a tank, and a UV laser to build the objects. For its part, nanoprinting or nanolithography refers to the manufacture of microstructures with a scale size being around nanometers, where the printing element is typically a formulation of monomers or polymers that is cured by heat or UV during the printing process. However, existing technologies require a costly investment due to the cost of equipment, specialized labor and long operating times. In addition, these technologies usually require the use of specific inks, which are usually difficult to manufacture, due to the long production times and the control systems that must be very precise. For its part, three-dimensional printing has severe limitations in terms of resolution and printing speed.

Micro- and nano-manufacture allows manufacturing multilayer composites, which are commonly determined by the degree of density of their layers. Multilayer materials with a large amount of intermaterial area can produce higher capacitances in super-capacitors, high mechanical strength, resistance to fatigue, better sensing capabilities, or better energy collection potential. A multilayer composite with multi-lamellar architecture has tight surface control and has application in pharmaceuticals, such as controlled release of pharmaceuticals.

A specific example of the solutions proposed in the state of the art for the manufacture of multilayer composites is described in document US2008100677, which refers to an ink supply system that includes a first ink, a supply module configured to store a first ink, a second ink supply module configured to store a second ink, and an ink path configured to transfer predetermined volumes of the first and second inks from the modules to a printhead, having electroconductive characteristics. However, the supply system described in document US2008100677 has several ink tanks, so its use could be complicated, as well as the cost of maintenance.

For its part, document CN106633713 refers to a consumable device produced by 3D printing, made of fiberglass reinforced in situ, comprising an extruder connected to the front end of a static mixer connected to the front end of the consumable, the forming mold is placed at the front end of a heating device, it is placed in the cooling gluing together with a laser calibrator, which is provided with a tension roller and a winding device. However, the consumable device is made up of several instruments, so its production cost could be very high. In addition, the consumable device is focused on the microglass-reinforced polymer three-dimensional printing consumable, in situ, so it could not print other types of materials, limiting its possible applications.

Another example is document CA2384414, which describes an inkjet printing device, comprising a combination of dispersion agitation means, heated ink supply and printhead and heated and adapted filtration regime. The use of this combination allows the printing of inks containing a non-magnetic pigment that exhibits a “soft laying” upon standing. However, the inkjet printing device may have low printing resolution and the printing speed may be very slow, due to the type of injection it uses.

Document JP2006326891 refers to a multilayer film manufacturing apparatus, comprising a dividing and cutting means for dividing the laminated flow, which is formed by alternately laminating two molten resins by means of a multilayer feed block, in a plurality of vertical places to the laminated surfaces to cut both ends of the laminated flow, a branching means for branching the laminated flows divided into branched flows so that the lamination surfaces thereof overlap each other up and down to contact each other and a matrix to allow the dimensionally adjusted branched flows to meet each other in a multi-layered state to form alternating laminated flows. However, the multilayer film manufacturing apparatus turns out to be a complex apparatus to use, since it involves active interaction and modification of the laminar flows.

Lastly, document CN103041702 describes an SCR (selective catalytic reduction) static mixer provided with leaves in the shape of artificial pine needles. A plurality of rows of equidistant steel tube grating bars welded between two sides of two short edges of a steel shell with a rectangular section, utilizing a flow field chaos effect generated by pine needle leaves to increase the turbulence of the fluid in a gas duct, so that the mixing effect of flue gas and ammonia can be greatly strengthened. However, the SCR static mixer is made up of several instruments, so its production cost could be very high and its operation would be complicated.

As a consequence, it has been sought to eliminate the drawbacks presented by the methods and devices for manufacturing multilayer composites currently used, developing a method for printing microlayers and multilayered nanostructures obtained by means of chaotic flows that, in addition to being fast and profitable, allows the fabrication of microlayers and nanostructures with good resolution. In addition to having a fast, robust and cost-effective manufacturing of microlayers and nanostructures, which are reproducible in a multi-material construction through a single-nozzle printhead.

### OBJECTS OF THE INVENTION

Taking into account the defects of the previous techniques, it is an object of the present invention to provide a method for printing microlayers and multilayered nanostructures that are formed by extrusion and that generate internal filaments obtained by means of chaotic flows through a fast, robust and profitable process.

Another object of the present invention is to provide a method for printing microlayers and multilayered nanostructures that allows the manufacturing of microlayers and nanostructures with good resolution.

It is yet another object of the present invention to provide a method for printing microlayers and multilayered nanostructures that is reproducible on a chaotic printer using a single nozzle printhead.

Another object of the present invention is to provide a method for printing microlayers and multilayered nanostructures that allows a user to have more degrees of freedom to be able to determine the multiscale resolution of a construct in a print, determine the internal multilayer architecture of the printed filaments, determine the composition of the multiple layers of the printed filaments, vary the architecture within a single printed filament, vary the composition within a single printed filament, vary the dimensions and external shapes of the printed filament.

Still another object of the present invention is to provide a method for printing microlayers and multilayered nanostructure that may carry out a continuous chaotic printing.

Finally, it is an object of the present invention to provide a method for printing microlayers and multilayered nanostructures that is fast, robust and cost-effective. These and other objects are achieved by a method for printing microlayers and multilayered nanostructures obtained by chaotic flows in accordance with the present invention.

### BRIEF DESCRIPTION OF THE INVENTION

A method for printing microlayers and multilayered nanostructures obtained by chaotic flows has been invented which is fast, cost-effective and with good resolution, which is also reproducible in a chaotic printer through a single-nozzle printhead.

In accordance with the above, one aspect of the present invention is a method for printing microlayers and multilayered nanostructures obtained by means of chaotic flows that comprises the following steps:
i) feeding a static mixer with at least two inks;
ii) promoting the inks to flow through the static mixer to create chaotic flows;
iii) promoting the solidification of the inks at the outlet of the static mixer to obtain a laminar structure and;
iv) printing the inks by extrusion.

Another aspect of the present invention refers to a chaotic printer for microlayers and multilayered nanostructures obtained by means of chaotic flows, comprising:
a) a pump, which allows to inject the inks to be printed;
b) a static mixing module, which in turn comprises: a flow distributor with at least two inlet ports, which keeps the inks injected into the static mixing module by the pump separated before being mixed; at least one static mixer, which allows the continuous creation of fine and complex nanostructures at the micrometer, submicrometer and nanometer level in the inks to be printed; at least one static mixer arrangement, which allows mixing the flows of the inks to be printed in a chaotic manner;
and; c) at least one printhead, which allows the extrusion of inks with internal nanostructures.

### BRIEF DESCRIPTION OF THE DRAWINGS

The novel aspects that are considered characteristic of the present invention will be established with particularity in the appended claims. However, some embodiments, features, and some objects and advantages thereof, will be better understood from the detailed description, when read in connection with the accompanying drawings, in which:

FIG. 1 shows the arrangement of the chaotic printer according to the present invention.

FIG. 2 shows the arrangement of the static mixer in accordance with the present invention.

FIG. 3 shows the longitudinal or cross-sectional microstructure of fiber obtained using different nozzle geometries in accordance with the present invention.

FIG. 4 shows optional configurations of the static mixer cap in accordance with the present invention.

FIG. 5 shows optional configurations of static mixer element arrangement and corresponding architectures within extruded filaments in accordance with the present invention.

FIG. 6 shows optional configurations of the container cylinder of the static mixer in accordance with the present invention.

FIG. 7 shows optional configurations of the extruder nozzle of the static mixer in accordance with the present invention.

FIG. 8 shows the development of multiscale architectures based on continuous chaotic printing in accordance with the present invention.

FIG. 9 shows the diameter of three individual nanofibers in accordance with the present invention.

FIG. 10 shows inks and bio-ink options to be printed using the static mixer in accordance with the present invention.

### DETAILED DESCRIPTION OF THE INVENTION

A method for printing microlayers and multilayered nanostructures obtained by chaotic flows has been found to be fast, cost-effective and with good resolution, reproducible on a chaotic printer through a single-nozzle printhead.

Thus, in accordance with the above, one aspect of the present invention is a method for printing microlayers and multilayered nanostructures obtained by means of chaotic flows that comprises the following steps:
i) feeding a static mixer with at least two inks;
ii) promoting the inks to flow through the static mixer to create chaotic flows;
iii) promoting the solidification of the inks at the outlet of the static mixer to obtain a laminar structure and;
iv) printing the inks by extrusion.

It should be noted that the method for printing microlayers and multilayered nanostructures obtained by chaotic flows works under the principle of continuous chaotic printing, which is the use of a simple laminar chaotic flow induced by a static mixer for the continuous creation of fine and complex structures at the micrometer and submicrometer level within polymer fibers.

In a preferred embodiment of the present invention, the inks are fed at a constant rate to the static mixer. Preferably, the inks are fed at a constant rate to the static mixer by a pump. More preferably, the pump is a syringe pump.

In another preferred embodiment of the present invention, after crosslinking the inks have a lamellar structure, that is, they have continuous composite fibers with complex microstructures. Preferably, the solidification of the alginate inks is carried out with a bath of calcium chloride solution, or another solution that contains divalent ions, which allows stable structures when the inks are printed. Preferably, the printed inks generate layers with an individual diameter between 0.2 to 1.7 μm. Preferably, the inks are printed at high extrusion speeds. More preferably, extrusion speeds are from 1 to 5 m of ink per minute. It should be noted that the method for printing microlayers and multilayered nanostructures obtained through chaotic flows allows a user to have more degrees of freedom to determine the multiscale resolution of a construction, since the coextrusion of multiple ink streams through a set of tubes concentric capillaries contained in a single nozzle are only defined by the diameter of the nozzle. Furthermore, chaotic flows are used for mixing in the laminar regime, where low velocity and high viscosity conditions preclude the use of turbulence to achieve homogeneity.

Another aspect of the present invention refers to a chaotic printer for microlayers and multilayered nanostructures obtained by means of chaotic flows, comprising:
a) a pump, which allows to inject the inks to be printed;
b) an static mixer module, which in turn comprises: b) a flow distributor with at least two inlet ports, which keeps the inks injected into the static mixing module by the pump separated before being mixed; at least one static mixer, which allows the continuous creation of fine and complex microstructures and nanostructures at micrometer, submicrometer and nanometer level in the inks to be printed; a container tube of the static mixers with or without inlet ports and with or without mobile sections allowing to vary configurations for the production of continuous filaments with changing internal structure; at least one static mixer arrangement, which allows mixing the flows of the inks to be printed in a chaotic manner
and; c) at least one printhead, which allows the extrusion of inks with internal nanostructures.

In a preferred embodiment of the present invention, at least two inks are injected into the pump. Preferably, the inks are fed at a constant rate to the static mixer by pumps. More preferably, the pump is a syringe pump. It should be noted that inks are structured fluids such as, for example, aqueous solutions of water-soluble polymers, which are solidified by a chemical or physical stimulus. The inks behave as Newtonian fluids in the laminar extrusion conditions (laminar flow regime) of the process.

In another preferred embodiment of the present invention, the static mixing module has a tubular structure. Preferably, the static mixer is a Kenics Miniaturized Static Mixer (KMS). Preferably, the static mixer comprises a cap. Preferably, the cap of the mixer comprises at least two holes that allow ink to be injected. Preferably, the mixer arrangement comprises helical elements with various configurations for laminar and turbulent flows. Preferably, the helical elements allow the flow to rotate between 0° to 90° with respect to a previous helical element. Preferably, the helical elements are contained in a tubular structure.

In another preferred embodiment of the present invention, the printhead comprises at least one nozzle that allows the inks to be extruded continuously in the form of a cylindrical filament or other geometric shapes. In an optional embodiment, the nozzle comprises an axial array with adjoining inlet ports that allow a crosslinking flow of printing ink to be coextruded. Preferably, the extruded inks have nanofibers with an individual diameter between 0.2 to 1.7 μm. Preferably the inks have high extrusion speeds. More preferably, extrusion speeds are from 1 to 5 m of ink per minute. It should be noted that in the laminar regime, the static mixer creates chaos by repeatedly dividing and reorienting the inks as they flow through each element.

The present invention may have multiple variants and embodiments based on the principles described herein. However, for a better understanding of the present invention, specific embodiments of the chaotic printer of microlayers and multilayered nanostructures obtained by means of chaotic flows in accordance with the present invention are described below.

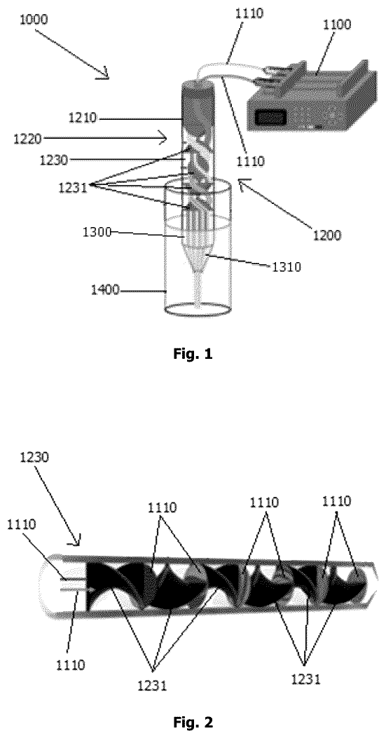

FIG. 1 shows the arrangement of the chaotic printer (1000), which is made up of a pump (1100), whose function is to inject the inks (1110). In this specific embodiment, two inks (1110) were injected into the static mixing module (1200), with a tubular structure that in turn comprises: a flow distributor (1210), which keeps the inks (1110) independent of each other before being mixed; a static mixer (1220), which allows the continuous creation of fine and complex nanostructures at the micrometer and submicrometer level in the inks (1110) to be printed. In this specific embodiment, the static mixer arrangement (1230) has 4 helical-shaped elements (1231), which allow the ink flows to be printed to be mixed chaotically, turning the ink flow (1110) 90° in each one of the helical-shaped elements (1231). In this specific embodiment, the chaotic printer (1000) has a printhead (1300) having only one nozzle (1310), through which inks (1110) with lamellar microstructures are extruded. In this specific embodiment, a flask (1400) is shown, in which the printhead (1300) is immersed in said flask.

In FIG. 2, the static mixer arrangement (1230) has 6 helical-shaped elements (1231), which allow the ink flows to be printed to be mixed chaotically, turning the ink flow (1110) 90° in each one of the helical-shaped elements (1231). This figure shows the splitting action of the flow, increasing the number of grooves and reducing the length scales, in a printing nozzle. This figure shows that the resolution, i.e. the number of elements and the distance between them, can be adjusted by using a different number of elements in a helical pattern.

The present invention will be better understood from the following examples, which are presented solely for illustrative purposes to allow a full understanding of the preferred embodiments of the present invention, without implying that there are no other embodiments not illustrated that may be implemented based on the detailed description above.

### Example 1

A test was carried out to perform the experimental arrangement of the chaotic printer of microlayers and multilayered nanostructures obtained by means of chaotic flows in accordance with the present invention.

The chaotic printer consisted of a syringe pump loaded with two 10 mL disposable syringes; a cylindrical static mixer containing 6 KSM helical elements and; a flask containing 550 ml of 2% calcium chloride. The syringes were loaded with two different green and red inks. In this specific test the inks were formed by suspensions of particles in 1% pristine alginate. The inks were then injected into the two inlet ports located on the printhead cap. The syringe pump was set to run at a flow rate of 0.8 to 1.5 mL/min. The experiments were carried out using nozzles with different internal diameters, in the range of 5.8 to 2 mm. The tube containing the KSM static mixer could be connected to a tip to further reduce the diameter of the final fiber. In the presented experiments, tip reducers with an outlet diameter of 4.2 and 1 mm were used. The tip outlet was immersed in 2% calcium chloride to crosslink the extruded fibers as soon as they exited the tube.

In this trial, sodium alginate was used to formulate different inks consisting of pristine alginate or suspensions of particles such as polymer microparticles, graphite microparticles, mammalian cells or bacteria. For example, several experiments were performed with red bacteria or two types of fluorescent microparticles, i.e., red and green bacteria or polymer beads, which were injected into the flow distributor ports of the mixer. The result was continuous composite fibers with complex microstructures that could be stabilized simply by solidification in a calcium chloride solution bath, which preserved the internal microstructure of the fibers with high fidelity and well-aligned microstructures with defined features that could be robustly manufactured along the printed fibers at remarkably high extrusion speeds of 1-5 m fiber/min. As shown below, a large amount of contact area was developed within each linear meter of these fibers. This printing strategy is also robust across a wide range of operating configurations. A series of printing experiments at different input flow rates were carried out to evaluate the stability of the printing process, while the flow regime is laminar and the fluid behaves in a Newtonian manner. The quality of the printing process was not affected by the flow used in a wide range of flow conditions.

### Example 2

A test was carried out to perform the nozzle design and its impact on printing of the chaotic printer of microlayers and multilayered nanostructures obtained by means of chaotic flows in accordance with the present invention.

The printing nozzles were manufactured in house. The static mixer elements (KSM elements) were designed using SolidWorks based on optimal ratios reported in the literature. The KSM element assemblies were printed on a P3 Mini Multi Lens 3D printer (EnvisionTEC, Detroit, Michigan) from ABS Flex White material. We use a length-radius ratio of L:3R. For example, for printheads with an internal diameter of 5.8 mm, the length and diameter of each separate KSM element were 8.7 mm and 5.8 mm, respectively. Sets of 2, 3, 4, 5, 6 and 7 KSM elements, attached to a tube cap, were manufactured to ensure correct orientation of the ink entry ports in the cap relative to the first KSM element. The cap was designed so that each ink inlet was placed on a different side of the first KSM element to maintain similar initial conditions in all experiments.

A cone-shaped nozzle tip with an exit diameter of 1 mm was used for this test, and stable fibers were obtained in a flow rate window of 0.003 to 5.0 ml/min. Having printheads with different geometries, i.e. different degrees of slope, did not disturb the lamellar structure generated by chaotic printing. The results obtained from the CFD simulation suggested that the angle of inclination of the conical tip of the printhead, i.e. the tip of the nozzle, did not seem to significantly affect the microstructure within the fiber in the range of flow rates tested and slopes of reduction. This was demonstrated by computational analysis of the effect of printhead tip shape on microstructure preservation of printed fibers produced from a mixture of alginate inks containing red and green particles.

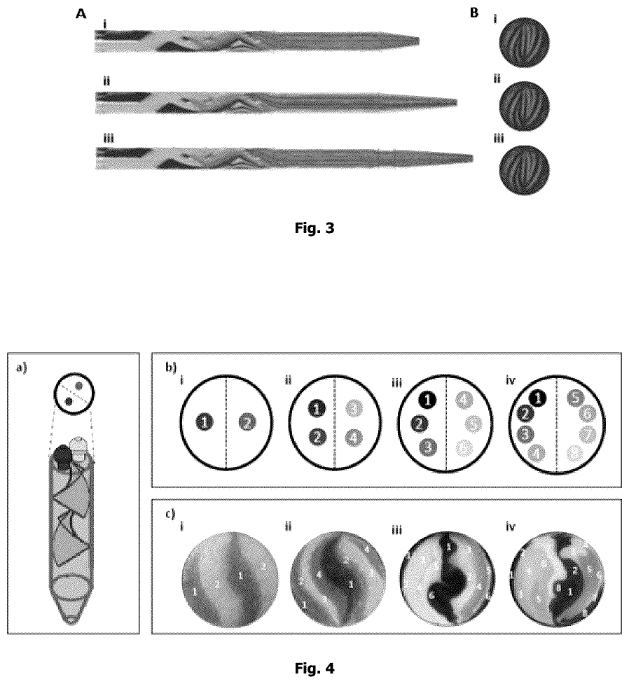

FIG. 3 shows the longitudinal or cross-sectional microstructure of fiber obtained using different nozzle geometries. Section A and section B show CFD results from particle tracking experiments in which two different inks containing red or green particles are co-extruded through a printhead containing 4 KSM elements. It can be seen that the lamellar structure is preserved when the outlet diameter is reduced, from 4 mm (inner diameter of the pipe section) to 2 mm (inner diameter of the tip), by means of tips that differ in their reduction slope.

### Example 3

A test was performed to determine flow changes in inks by different arrangements in the cylinder head in accordance with the present invention.

In this test, different arrangements in the cylinder head were analyzed to determine the movement of the ink flows.

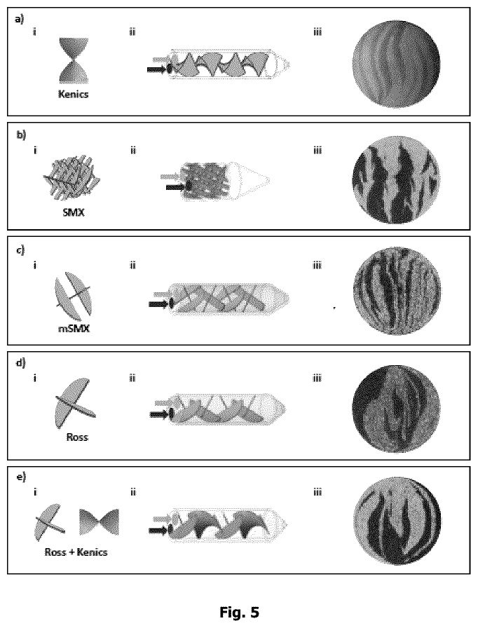

In FIG. 4, different optional configurations of the static mixer cap are shown, the different arrangements that were analyzed in this test. In section a), the cylinder head with two holes is shown. In section b), the cylinder head is shown with four different configurations of holes. In section c), the distribution of the flows of each cap, respectively, where the different flows that can be obtained by changing the arrangement of the cylinder head holes can be observed by means of the identification numbers.

### Example 4

An experiment was carried out to analyze different configurations of the static mixing elements and the corresponding architectures within the extruded filaments in accordance with the present invention.

Different configurations of static mixer elements were used for this test, such as the Kenics, SMX, mSMX, Ross, Ross+Kenics static mixer.

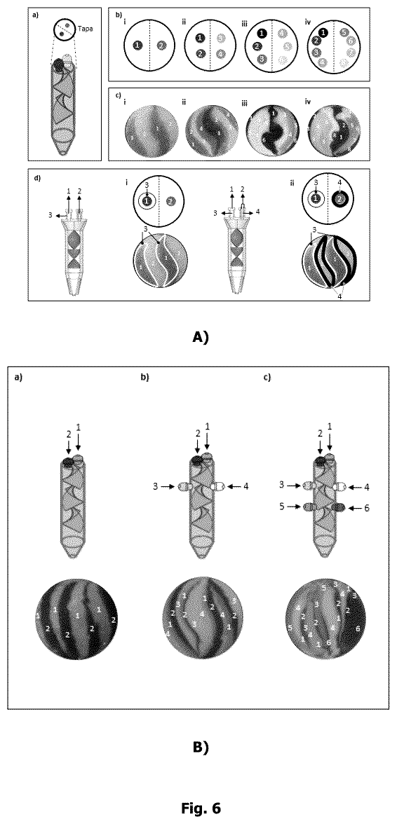

In FIG. 5, in subsections a) to e) with the different configurations of the static mixing elements are shown. Section a) shows a Kenics static mixer; section b) shows an SMX static mixer; section c) shows an mSMX static mixer; section d) shows a Ross static mixer and; section e) shows a Ross+Kenics static mixer, each one with its corresponding configurations and the architectures inside the extruded filaments.

### Example 5

A test was carried out to analyze different optional configurations of the static mixer container cylinder in accordance with the present invention.

In this test, three different configurations of the static mixer container cylinder were tested.

In sections A) and B) of FIG. 6, three different configurations of the container cylinder of the static mixer are shown. In section a), an arrangement without side inlets and with two holes in the cap is shown, with this arrangement, eight different layers were obtained. In section b), an arrangement without side inlets and with two holes in the cap is shown, with this arrangement, 14 layers were obtained. In section c), an arrangement with four side inlets and with two holes in the cap is shown, with this arrangement, 20 layers were obtained. In section d), an arrangement with coaxial ports injecting two inks is shown. In section B), three different cylinders are shown with the arrangements previously indicated.

### Example 6

A test was conducted to analyze optional configurations of the extruder nozzle of the static mixer in accordance with the present invention.

Three different nozzles with different sizes were used in this test.

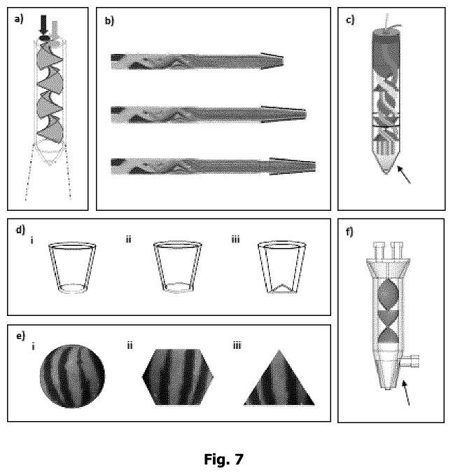

Optional static mixer extruder nozzle configurations are shown in FIG. 7. In section a), the cylinder with a helical static mixer, used in the present test, is shown. In section b), the different sizes of the nozzles are shown. In section (c), the cylinder with a metal tip is shown. In section d), the three different types of nozzles that were used are shown, that is, a circular nozzle, an hexagonal nozzle and a triangular nozzle. In section e), different types of flow that were formed, using the previously mentioned nozzles, respectively were shown. In section f), the cylinder with a coaxial tip is shown.

### Example 7

A trial was conducted to perform the printing coupling of the chaotic printer of microlayers and multilayered nanostructures obtained by chaotic flows with other printing techniques in accordance with the present invention.

Coupling of chaotic printing with other manufacturing techniques was performed in this test. The combination of continuous chaotic printing with other manufacturing technologies, for example molding, electrospinning, or robotic assembly, led to the manufacturing of complex multiscale architectures with high degrees of predictable external shapes and internal microstructure. During printing, these fibers can be rearranged into macrostructures or individual fibers can be further reduced in diameter, preserving their lamellar architecture. The integration of this multi-material printhead in a 3D printer can thus enable rapid manufacturing of multi-material and/or multicellular constructs, which exhibit a large amount of material interface with a complex and tunable architecture as we will show later in this contribution. Furthermore, to demonstrate the latter, the fiber diameter was reduced and chaotic printing was combined with other techniques for the production of nanofibers containing finely controlled structures at the submicron scale. As an example, a 2-element KSM printhead was coupled with an electrospinning device that produced a nanofiber mesh containing well-defined nanostructures. Fibers with a mean diameter <300 nm were formed. Close inspection by photoinduced force microscopy (PIFM) revealed multilayered nanostructures with mean striation thicknesses in the range of 75-100 nm. These results demonstrated that the microstructure created by chaotic 3D printing can be further reduced by three orders of magnitude using electrospinning. The manufacturing of fibers with fine lamellar microstructures allowed the design of materials with relevant applications.

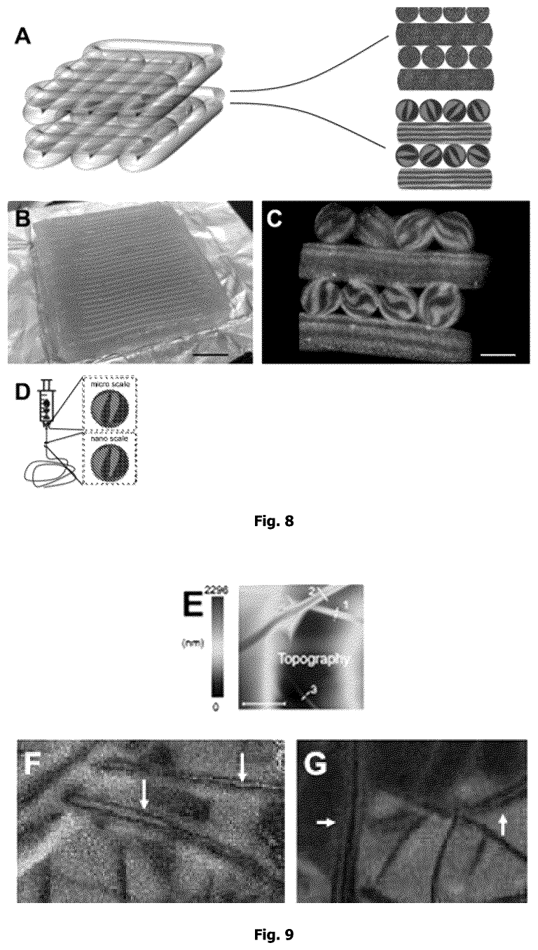

FIG. 8 shows the development of multiscale architectures based on continuous chaotic 3D printing. Section A shows an upper figure showing the structure of the inks of a conventional three-dimensional printing by extrusion. The lower figure shows the structure of the printing inks with the chaotic printer of microlayers and multilayered nanostructures obtained by means of chaotic flows. In section B, the print of a long fiber arranged in a hydrogel construct at macro scale (3 cm×3 cm×4 mm), on a scale bar was shown: 5 mm. In section C, the cross section of the macroconstruction showing the internal microstructures was shown. Scale bar: 1 mm. In sections D-G, the chaotic printing of fibers is shown together with electrospinning. Specifically, section D shows the schematic representation of the coupling between continuous chaotic printing and an electrospinning platform; an ink composed of a pristine alginate ink (4% sodium alginate in water) and an ink composed of a polyethylene oxide mixture (7% polyethylene oxide in water), coextruded through a chaotic printhead and electrospun into a nanomat.

### Example 8

A trial was conducted to make ink formulations and verify their printing characteristics in accordance with the present invention.

Different ink formulations were made in this test. The inks consisted of particles suspended in alginate or pristine alginate solutions (CAS 9005-38-3, Sigma Aldrich, St. Louis, MO, USA). In a first set of experiments, fibers loaded with red or green fluorescent particles were manufactured. Red and green fluorescent inks were prepared by suspending 1 part of commercial fluorescent particles (Fluor Green 5404 or Fluor Hot Pink 5407; Createx Colors; East Granby, CT, USA) in 9 parts of a 1% aqueous solution of sodium alginate (Sigma Aldrich, St. Louis, MO, USA). The fluorescent particles were previously subjected to three cycles of washing, centrifugation and decantation to eliminate the surfactants present in the commercial preparation. Chaotic printing was also used to make fibers containing an overall concentration of 0.5% graphite by co-extruding a suspension of 1.0% graphite in alginate solution (1%) and pristine alginate solution (1%) through printheads containing 2, 4 or 6 KSM elements. In addition, control fibers were obtained by extruding pristine alginate (without graphite microparticles) through a vacuum tube, or by co-extruding two ink streams containing 0.5% graphite microparticles well hand-mixed in alginate. In a third set of experiments, fluorescent inks based on suspensions of fluorescent bacteria E. coli were used. These fluorescent bacteria were engineered to produce green fluorescent protein (GFP) or red fluorescent protein (RFP). Bacterial inks were prepared by mixing E. coli, expressing GFP or RFP, in a 2% alginate solution supplemented with 2% luria-bertani (LB) broth (Sigma Aldrich, St. Louis, MO, USA). For the preparation of the ink, bacterial strains were cultivated for 48 h at 37° C. in LB media. Bacterial pellets, recovered by centrifugation, were washed and resuspended twice in LB-alginate medium. The optical density of the resuspended pellets was adjusted to 0.1 absorbance units before printing (approximately 5 colony-forming units per ml per ml (CFU/ml)). Fibers were printed at a flow rate of 1.5 ml/min and cultured by immersion in LB media for 48 hours. The number of viable cells present in the fibers at different times was determined by conventional plate counting methods. Briefly, 0.1 g fiber samples were grown in tubes containing LB media. The number of viable cells was determined by washing the 0.1 g samples in 1× phosphate buffered saline (PBS) pH 7.4 (Gibco, Life Technologies, Carlsbad, CA) to remove bacteria accumulated on LB media. Each sample was disaggregated and homogenized in 0.9 ml of PBS. The resulting bacterial suspensions were decimally diluted, seeded on 1.5% LB-Agar (Sigma Aldrich, St. Louis, MO, USA) and incubated at 37° C. for 36-48 h. Murine muscle cells (C2C12 cell line, ATCC CRL 1772) were also printed in 1% alginate inks supplemented with 3% methacryloyl gelatin (GelMA) added with a photoinitiator (0.01% LAP). For this, a first ink contained only alginate and GelMA, while the second was loaded with C2C12 cells at a concentration of 3×10⁶ cells mL⁻¹. Cell-loaded printed fibers, obtained by immersion in alginate and then crosslinked by exposure to UV light at 400 nm for 30 s, were immersed in DMEM culture medium (Gibco, USA) and incubated for 20 days at 37° C. in a 5% CO₂ atmosphere. The culture medium was renewed every four days during the culture period. In a fifth set of experiments, electrospun nanofiber mats were produced by combining chaotic online 3D printing with an electrospinning technique. The fibers produced by chaotic 3D printing continuously solidified as they were generated by direct feeding into an electrospinning apparatus. In these experiments, two different ink pairs were explored for experiments combining continuous chaotic 3D printing and electrospinning. First, fibers were chaotically printed by coextrusion of a pristine alginate ink (4% sodium alginate in water) and polyethylene oxide (7% PEO in water). The resulting PEO-alginate fibers were electrospun (in ine) to produce nanofiber mats.

In this test, it was shown that the method for printing microlayers and multilayered nanostructures obtained by chaotic flows and the chaotic printer of microlayers and multilayered nanostructures obtained by chaotic flows allowed users of continuous chaotic printing to have more freedom degrees to determine the multiscale resolution of a printed construct, since the size of the resulting structure is not restricted by the diameter of the nozzle, but by the static mixer located inside the cylinder fed by inks. For example, for the two-stream system, the number of lamellae increases exponentially according to the simple model s=2″, where s is the number of lamellae or grooves within the construct and n is the number of KSM elements within the tube of extrusion. Two ink streams co-injected into the printhead will generate 4, 8, 16, 32, 64, and 128 distinctive streams of fluid as they pass through a series of 2, 3, 4, 5, 6, and 7 KSM elements, respectively. The average resolution of the structure will then be governed by the average groove of the construction, given by D/s, if D is the internal diameter of the nozzle. Since stretching is exponential in chaotic flows, the reduction in length scale is also exponential, as is the increase of the resolution, i.e. more packed lines. In this test, the transverse diameter of the fibers was 2 mm and grooves were observed with mean resolutions of 500, 250, 125, 62.5 and 31.75 m by continuous printing with KSM elements of 2, 3, 4, 5 and 6, respectively. Even when 6 KSM elements were used, the distinctive lamellae could be discriminated in the array of 64 aligned grooves. The resolution values obtained through 6 elements already exceeded those achievable by state-of-the-art commercial extrusion 3D printers (75-100 μm) using hydrogel-based inks, i.e. commercial bioprinters.

### Example 9

A test was carried out to characterize the printed inks of the chaotic printer of microlayers and multilayered nanostructures obtained by means of chaotic flows in accordance with the present invention.

In this test, the characterization of the printed inks of the chaotic printer was carried out, where the microstructure of the fibers produced by the chaotic printing was analyzed by optical microscopy using an Axio Imager M2 microscope (Zeiss, Germany) equipped with Colibri.2 led lighting and an Apotome.2 system (Zeiss, Germany). Bright field fluorescence micrographs were used to document the lamellar structures within the longitudinal segments and cross sections of the fibers. Wide-field images (up to 20 cm2) were created using a stitching algorithm included as part of the microscope software (Axio Imager Software, Zeiss, Germany). Fibers were frozen by flash immersion in liquid nitrogen to facilitate sectioning and preserve the microstructure. The microstructure of nanofibers produced by chaotic printing along with electrospinning was analyzed by atomic force microscopy (AFM) and force microscopy photoinduced (PIFM), a nano-IR technique (Figure S3). Mechanical tests of graphite-alginate fibers were used on a universal test bench machine (Tinus Olsen h10kn; PA; USA), with a 50 N load cell at a speed of 35 mm min-1, to assess the mechanical properties of alginate fibers containing 0.5% graphite particles and produced by different printing strategies. Specifically, tensile tests were performed on fibers produced from a mixture of 0.5% alginate graphite microparticles, generated either by random mixing and extrusion through an empty pipe or by continuous chaotic printing using 2, 4, or 6 KSM elements. In these experiments, the gauge length between clamps was set to 25 mm. Stress-strain curves were obtained for each of the five different formulations. We determined the maximum tensile strength, stress at break, and Young's modulus of the fibers from stress-strain data.

FIG. 9 shows the diameter of three individual nanofibers. In sections E, F, and G, an AFM image is shown in section E showing the diameter of three individual nanofibers of [(1) 0.82 μm, (2) 1.05 μm, and (3) 0.437 μm] inside the electrospun mesh. Scale bar: 5 μm. Shown in sections F and G, a PIFM is shown revealing the lamellar nature of the nanostructure within a nanofiber (white arrows) originated using a 2-element KSM printhead, as shown in section F, and a 3-element KSM printhead, as shown in section G. On a scale bar: 1 μm.

As it was possible to observe in this essay, a remarkable characteristic of the continuous chaotic printing is that the structure obtained is totally predictable, since the chaotic flows are deterministic systems, as in any chaotic system. The simulation results, obtained by solving the Navier-Stoke equations of fluid motion using computational fluid dynamics (CFD), closely reproduced the transverse lamellar microarchitecture within the fibers.

### Example 10

An attempt was made to perform a computational simulation of a three-dimensional model in accordance with the present invention.

A simulation of the printing method was performed using a finite element model (FEM) approach in COMSOL Multiphysics 5. First, a 3D model was designed and solved, using laminar flow equations and a stationary solver, to determine the velocity field in the system for the various experimental scenarios explored. A fluid viscosity value of 1P and a density of 1000 kg/m3 were used. Next, a time-dependent solver was used to track up to 10⁵ massless particles using particle tracking for fluid flow physics in the previously solved steady-state velocity field. The simulation was discretized with a reasonable and fine mesh composed of free triangular elements. Mesh sensitivity studies were performed to ensure consistency of results. Non-slip boundary conditions were imposed on the fluid flow simulation, while a freezing boundary condition was used for the particle tracking module. The length of the interface was determined by importing the output results of the cross section of the fibers, a set of points helped to describe the position of the interface in the CorelDraw X5 software (Corel Corporation, Canada), drawing Bezier curves on the grooves and setting the length of the curves using the software.

For this trial, light microscopy and image analysis techniques were used to characterize the fine range of lamellae experimentally produced by continuous chaotic printing. The groove thickness distribution (STD) in the cross sections of the graphite/alginate fibers was calculated by drawing several center lines of representative cross sections and then calculating the distance between the grooves along those lines. Then, the frequency distribution and the cumulative ETS were measured. For the printed constructions 4, 5, 6 and 7 KSM elements were used. As a result, it was observed that these KSM elements presented distributions that exhibit self-similarity, one of the distinctive characteristics of chaotic processes. As explained, for any of these particular cases, the average groove thickness could be calculated as fiber diameter/number of grooves. However, due to the highly skewed shape of the distribution towards smaller striation thicknesses, the mean groove thickness less than the mean groove value. For example, for the case where 4 KSM elements were used, the average groove thickness could be calculated as 2 mm/16 grooves equals 125 μm. In fact, 50% of the grooves measured less than 125 μm, but the corresponding ETS showed that most of the grooves had a mean value of about 75 μm. This has implications for crucial processes like mass and heat transfer. Diffusion distances in these constructs decreased rapidly as the number of elements used for printing increased.

### Example 11

Trials were conducted to analyze option configurations of inks and bio-inks to be printed using the static mixer in accordance with the present invention.

The tests confirm the ability of the chaotic printer to make filaments containing bacteria, mammalian cells, or multiple empty channels.

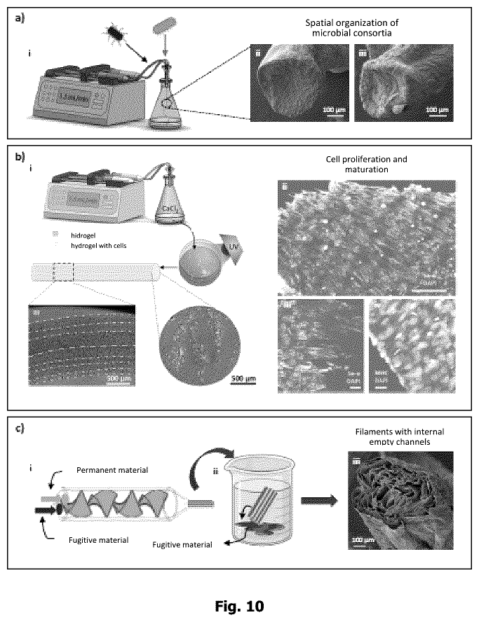

FIG. 10 shows sections a), b) and c) with images of the three experiments described below. In a first set of experiments, bacterial inks were prepared by mixing Escherichia coli or Lactobacillus rhamnosus with a 2% alginate solution, supplemented with 2.0% Luria-Bertani (LB) broth (Sigma Aldrich, St. Louis, MO, USA) or 5.2% Man-Rogosa-Sharpe (MRS) broth (Merck Millipore, Burlington, NJ, USA) for E. coli or L. rhamnosus, respectively. For the preparation of each ink, the bacterial strains were cultivated in separate sterile containers for 24 h at 37° C. in the culture medium established for each strain. Bacterial cultures were centrifuged and resuspended in aqueous alginate-culture medium. Before printing, the optical density of the re-suspended bacterial colonies was adjusted to 0.1 or 0.025 absorbance units for E. coli or L. rhamnosus, respectively (about 7×10⁷ colony-forming units per mL (CFU mL⁻¹). The filaments were printed at a flow rate of 1.5 mL min⁻¹ and cultured for 12 h by immersion in a mixture of LB and MRS media combined in a 1:1 ratio. The number of viable bacteria present on the fibers at different times was determined by conventional microbiological plate count methods. The number of viable bacteria was determined by washing the 0.1 g samples in 1× phosphate buffered saline (PBS) pH 7.4 (Gibco, Life Technologies, Carlsbad, CA) to remove bacteria accumulated on LB media. Each sample was disaggregated and homogenized in 0.9 ml of PBS. The resulting bacterial suspensions were decimally diluted, seeded on 1.5% LB-Agar (Sigma Aldrich, St. Louis, MO, USA) or MRS-AGAR plates, and incubated at 37° C. for 48 h.

In a second set of experiments, murine muscle cells (C2C12 cell line, ATCC CRL 1772) suspended in 1% alginate inks supplemented with 3% methacrylated gelatin (GelMA) were printed in the presence of a photoinitiator (0.067% LAP). For this, a first ink contained only alginate and GelMA, while the second contained C2C12 cells at a concentration of 3×10⁶ cells mL⁻¹. Cell-loaded printed fibers, obtained by immersion in alginate and then crosslinked by exposure to UV light at 365 nm for 30 s, were immersed in DMEM culture medium (Gibco, USA) and incubated for 28 days at 37° C. in a 5% CO₂ atmosphere. The culture medium was renewed every three days during the culture period. The maturation of the cells contained in the filaments was evaluated through immunostaining techniques. Briefly, primary antibodies that bind to the sarcomeric actin (sa-α), or heavy chain myosin (MHC) proteins were used. Subsequently, secondary antibodies that send a fluorescence signal when they recognize the primary antibodies were applied. Cell nuclei were stained with 4′,6-diamidino-2-phenylindole (DAPI) dye. Fluorescence signals were captured using an Axio Observer.Z1 microscope (Zeiss, Germany) equipped with Colibri.2 LED illumination and an Apotome.2 system (Zeiss).

In a final set of experiments, a fugitive ink was used to create hollow channels within the filaments produced by the chaotic printer. The fugitive ink consisted of a 10% solution of pluronic acid (Sigma Aldrich, St. Louis, MO, USA) in 10% deionized water. The permanent ink consisted of a 2% alginate aqueous solution (Sigma Aldrich, St. Louis, MO, USA). The fugitive material and the permanent material were extruded at the same time through the chaotic printer at a room temperature of 25° C. A 4% aqueous calcium chloride solution was used to crosslink the alginate ink. The fugitive material was released from the filament without carrying out additional procedures, since pluronic acid is not crosslinked by calcium chloride. The filaments were immersed in liquid nitrogen, and lyophilized for 12 h to visualize the hollow channels using a scanning electron microscope (Zeiss, Germany).

In accordance with the above, it can be seen that the method for printing microlayers and multilayered nanostructures obtained by chaotic flows has been devised to be fast and cost-effective, allowing the manufacturing of microlayers and nanostructures with good resolution, and it will be evident for any person skilled in the art that the embodiments of the printing method of microlayers and multilayered nanostructures obtained by means of chaotic flows as described above and illustrated in the accompanying drawings, are only illustrative and not limiting of the present invention, since they are possible numerous major changes in its details without departing from the scope of the invention.

Therefore, the present invention should not be considered as restricted except as required by the prior art and by the scope of the appended claims.

1. A method for fabricating multilayered micro and nanostructures using chaotic flows comprising the following steps: i) feeding a printhead comprising a static mixer with at least two inks; ii) promoting the inks to flow through the static mixer to create chaotic flows; iii) promoting the solidification of the inks at the outlet of the static mixer to obtain a multilayered structure and; iv) printing the inks by extrusion, wherein two or more inks of the at least two inks are permanent.

2. The method for fabricating multilayered micro and nanostructures using chaotic flows in accordance with claim 1, wherein the inks are fed at a constant speed to the printhead.

3. The method for fabricating multilayered micro and nanostructures using chaotic flows in accordance with claim 2, wherein the inks are fed at a constant speed to the printhead by means of a pumping system.

4. The method for fabricating multilayered micro and nanostructures using chaotic flows in accordance with claim 3, wherein the pumping system is a syringe.

5. (canceled)

6. The method for fabricating multilayered micro and nanostructures using chaotic flows in accordance with claim 1, wherein the promotion of the solidification of the inks is carried out with a bath of calcium chloride solution or another salt that generates divalent ions.

7. (canceled)

8. The method for fabricating multilayered micro and nanostructures using chaotic flows in accordance with claim 1, wherein the inks are printed at a high extrusion speed.

9. The method for fabricating multilayered micro and nanostructures using chaotic flows in accordance with claim 8, wherein the extrusion speed is from 1 to 5 m of ink per minute.

10.-20. (canceled)

21. A printhead for fabricating multilayered micro and nanostructures, comprising a printhead in a plurality of arrangements comprising:
a) a flow distributor with at least two inlet ports;
b) a static mixer in a plurality of arrangements comprising at least one mixing element, which enables the creation of multilayered patterns produced by chaotic advection;
c) a container tube for the static mixer comprising a 0 or more side inlet ports which enables the production of continuous filaments with varying internal radial or axial structures;
d) a lid containing at least two inlet ports to enable the production of continuous filaments with varying longitudinal or cross-sectional microstructure; and
e) a printhead nozzle to produce filaments with different cross-sectional shapes and dimensions.

22. The printhead according to claim 21, wherein the tube container further comprises interchangeable sections allowing to vary configurations for the production of continuous filaments with changing internal structure.

23. The printhead according to claim 21, wherein the static mixer comprises helical elements with various configurations.

24. The printhead according to claim 23, wherein each helical element is rotated between 0° and 90° with respect to a previous helical element.

25. The printhead according to claim 21, wherein the static mixer is a Kenics static mixer (KSM), or a SMX static mixer, or modified SMX (mSMX) static mixer, or a Ross static mixer, or any combination of the mixing elements of these static mixers, which enables the generation of plurality of distinct inner patterns or architectures depending on the configuration and number of static mixers selected.

26. The printhead according to claim 21, wherein the side inlet port(s) outfall at different heights of the container tube (flowing into a specific static mixing element), which enables the generation of a plurality of distinct inner patterns with varying layer thickness, depending on the side inlet port position(s).

27. The printer according to claim 21, wherein the inlet port(s) at the container tube or the lid are adapted with a co-axial inlet for coextruding an additional ink, which enables the generation of layers lined with a secondary ink.

28. The printer according to claim 21, wherein the printhead nozzle includes at least one co-axial inlet port for coextruding an additional ink or material, for example, a crosslinking agent.

29. The printer according to claim 21, wherein the printhead nozzle is made by or coated with a conductive material, which enables the adaptation to an electrospinning or electrowriting set up.
